(19) United States
(12) Patent Application Publication
(10) Pub. No.: US 2025/0260194 A1
(43) Pub. Date: Aug. 14, 2025

(54) CABLE ASSEMBLY INCLUDING A HOOD ADAPTER AND HOOD

(71) Applicant: HARTING International Innovation AG, Biel (CH)

(72) Inventors: Sarah Southerland, Paxton, MA (US); Karol Goszczynski, Elgin, IL (US)

(73) Assignee: HARTING International Innovation AG, Biel (CH)

(21) Appl. No.: 19/041,607

(22) Filed: Jan. 30, 2025

Related U.S. Application Data
(60) Provisional application No. 63/551,770, filed on Feb. 9, 2024.

(30) Foreign Application Priority Data
Jun. 4, 2024 (GB) 2407887.5

(51) Int. Cl. H01R 13/52

(52) U.S. Cl. CPC H01R 13/5213

(57) ABSTRACT

A cable assembly includes a cable including an outer sheath and at least one conductor within the sheath, a connector coupled to an end of the cable, the connector having at least one contact that is coupled to the at least one conductor, an adapter and a hood. The adapter has a first part and a second part that define an adapter cavity, a first adapter opening at a first end of the adapter and a second adapter opening at a second end of the adapter, and the first part and the second part being movable relative to each other. The hood has a sidewall that defines a hood interior and includes a first hood opening at a first end of the hood and a second hood opening at a second end of the hood. The adapter has a first position in which part of the cable may be inserted into the adapter cavity, and the adapter has a second position in which the part of the cable is trapped within the adapter, in the second position the cable extends out of the second adapter opening and the connector extends out of the first adapter opening. The adapter is received within the hood interior so that the connector extends at least partly out of the first opening and the cable extends through the second opening.

### RELATED APPLICATIONS

This application claims the benefit of priority of U.S. Provisional Application No. 63/551,770, filed on Feb. 9, 2024, and GB Application No. GB2407887.5, filed Jun. 4, 2024. The entire contents of those applications are relied upon and incorporated herein by reference in their entirety.

### TECHNICAL FIELD

The present disclosure relates generally to cable assembly including an adapter for the cable and a hood of the cable assembly.

### BACKGROUND

To enable a more robust cable with an end connector to be provided with a hood and gland, the cable was provided without any end connector installed on the cable, or the cable was cut to remove the end connector. Then, the hood and gland were installed onto the cable and then the end connector installed onto the cable and relative to the hood. It can be difficult and time consuming to make the various connections between multiple wires of the cable and the end connector, and the robustness of the connections can be reduced compared to an end connector that is factory installed on the cable.

### SUMMARY

In at least some implementations, a cable assembly includes a cable including an outer sheath and at least one conductor within the sheath, a connector coupled to an end of the cable, the connector having at least one contact that is coupled to the at least one conductor, an adapter and a hood. The adapter has a first part and a second part that define an adapter cavity, a first adapter opening at a first end of the adapter and a second adapter opening at a second end of the adapter, and the first part and the second part being movable relative to each other. The hood has a sidewall that defines a hood interior and includes a first hood opening at a first end of the hood and a second hood opening at a second end of the hood. The adapter has a first position in which part of the cable may be inserted into the adapter cavity, and the adapter has a second position in which the part of the cable is trapped within the adapter, in the second position the cable extends out of the second adapter opening and the connector extends out of the first adapter opening. The adapter is received within the hood interior so that the connector extends at least partly out of the first opening and the cable extends through the second opening.

In at least some embodiments, the cable assembly is configured for operation and installation in industrial applications, in particular for harsh environments where high demands are placed on tightness against water and dirt, and where the cable assembly is subjected to vibrations with high magnitudes. The hood used to receive the adapter and cable is preferably a heavy-duty electrical connector that is sealed to withstand harsh environmental conditions.

In at least some implementations, the sidewall of the hood is circumferentially continuous along at least part of a length of the hood between the first end and the second end. In at least some implementations, a retainer that couples together the hood and the adapter to retain a position of the adapter in the hood interior.

In at least some implementations, the adapter includes a seal that engages and surrounds a periphery of part of the connector to provide a seal between the adapter and the connector.

In at least some implementations, the adapter includes a hinge between the first part and the second part that permits hinged relative movement between the first part and the second part. In at least some implementations, the hinge extends in a direction parallel to a central axis of the cable. In at least some implementations, the adapter is a clamshell body. In at least some implementations, the hinge extends in a direction perpendicular to a central axis of the cable.

In at least some implementations, the first part is separate from the second part in the first position of the adapter and the first part is releasably coupled to the second part in the second position of the adapter. In at least some implementations, the first part and the second part have complementary connection features that are releasably connected in the second position of the adapter. In at least some implementations, the first part is a U-shaped body having two spaced apart legs each having a first end and a second end opposite to the first end, and the U-shaped body has a central portion connected to the first end of each leg, and wherein the U-shaped body is connected to the second part of the adapter by connection features on the legs and so that the central portion overlies part of the connector.

In at least some implementations, the adapter includes a compliant body that defines at least part of the adapter cavity, and which is compressed against one or both of the connector and the cable in the second position of the adapter.

In at least some implementations, the connector includes a retainer tab arranged to releasably retain the connector in a socket of a mating connector, and wherein the retainer tab is located outside of the adapter. In at least some implementations, the adapter when in the second position moves the retainer tab to a position permitting removal of the connector from said mating connector.

### BRIEF DESCRIPTION OF THE DRAWINGS

The following detailed description of preferred implementations and best mode will be set forth with regard to the accompanying drawings, in which:

FIG. 1 is a perspective view of a cable assembly showing a cable with a connector at one end, a gland and an outer hood between the gland and the connector;

FIG. 2 is a sectional view of the cable assembly showing an adapter received within the hood;

FIG. 3 is a perspective view of the cable assembly with the hood and gland removed;

FIG. 4 is a side view of a cable assembly showing an adapter in a first position;

FIG. 5 is a perspective view of the adapter in the first position;

FIG. 6 is a perspective view of the adapter in the first position;

FIG. 7 is a perspective view of a cable assembly showing an adapter in a first position and a cable received in the adapter;

FIG. 8 is a perspective view of the adapter in the first position with the cable removed;

FIG. 9 is a perspective view of the adapter in the first position;

FIG. 10 is a perspective view of a cable assembly with an adapter shown in a second position with a cable received therein;

FIG. 11 is a perspective view of the adapter in the second position; and

FIG. 12 is a perspective view of the adapter in the first position.

### DETAILED DESCRIPTION

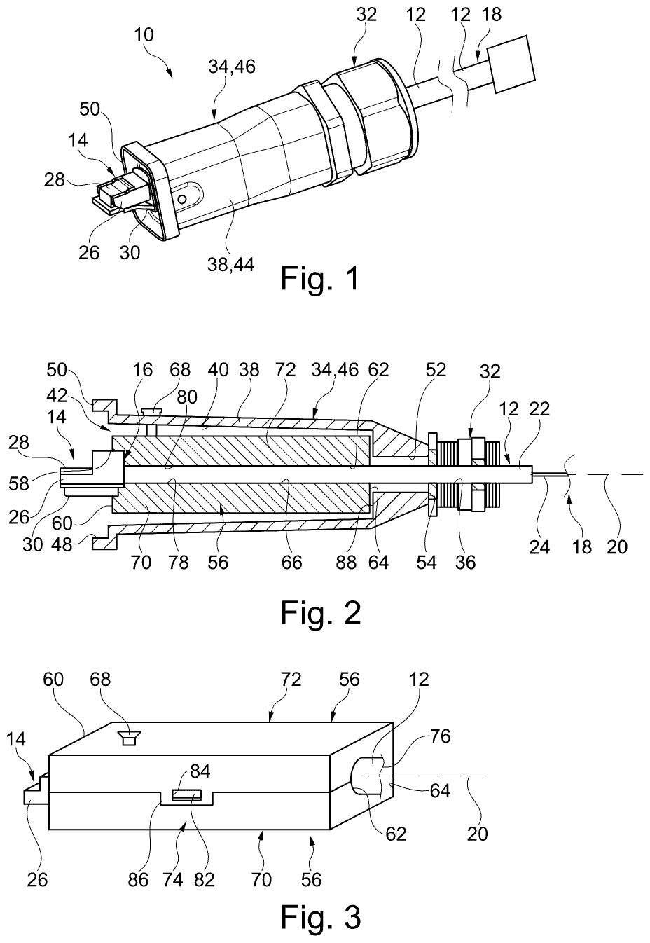

Referring in more detail to the drawings, FIG. 1 shows a cable assembly 10 including a cable 12 and a connector 14 at an end of the cable 12. In this embodiment, the cable assembly 10 is for a RJ45 type cable 12 and connector 14, although other cable and connector types may be used. As shown in FIG. 2, the cable 12 extends between opposite ends 16, 18 and has a central axis 20. An outer sheath 22 or insulator layer typically of a polymeric material extends between the ends 16, 18, as does one or more conductors 24 that are received within and surrounded by the outer sheath 22. The conductor(s) 24 typically are solid or twisted metal wires that are electrically conductive (e.g. copper or aluminum). The cable 12 can include other things, like internal insulators or shields, as desired and as is known in the art.

To facilitate connecting the conductor(s) 24 to another device, a connector 14 is provided at one or both ends of the cable 12. The connector 14 includes a body 26 with an exterior shape designed to facilitate connection with a mating connector, such as by a plug-in coupling. Accessible from an exterior of the body 26, the connector 14 includes one or more contacts 28 that may each be coupled to a separate conductor 24 of the cable 12, and are arranged for electrically conductive coupling with a contact of a mating connector, within an interior of the body 26, in known manner. The connector 14 may include a retaining structure adapted to releasably retain the connector 14 in a coupled position relative to a mating connector. In the example shown, the retaining structure is a retaining tab 30 that is cantilevered at one end to the connector 14 body 26 and that is flexible, resilient and arranged for a snap-fit within a slot of the mating connector, in a known manner.

For a more robust cable assembly 10, a gland 32 is secured to the cable 12 spaced from the connector 14 and a hood 34 is provided over the cable 12 between the gland 32 and the connector 14. The gland 32 and the hood 34 may provide protection from contaminants and facilitate coupling and uncoupling the cable 12 and/or the connector 14 to a mating connector of a device or bulkhead, which may be arranged for connection with multiple cables, in at least some implementations. The gland 32 is tubular and may include multiple components fitted together. An inner surface of the gland 32 defines a gland passage 36 (FIG. 2) and may be securely received on the outer sheath 22 of the cable 12 with a forward end of the gland 32 arranged at a desired distance from the connector 14. The outer diameter of the gland passage 36 may be slightly smaller than the outer diameter of the cable 12, such that the gland 32 may provide strain relief for the cable 12. The distance may be such that the hood 34 is located in a desired orientation and position relative to the connector 14 when in contact or connected with the gland 32. To facilitate assembly of the cable assembly 10, the gland 32 may be designed so that it can be installed onto the cable 12 with the connector 14 attached to the cable 12. And the gland 32 and hood 34 may be connected together prior to installation onto the cable 12, if desired.

The hood 34 is received between the gland 32 and the connector 14, and may be connected to the gland 32 if desired. The hood 34 is tubular and includes a sidewall 38 with an inner surface 40 that defines at least part of a hood interior 42 through which the cable 12 extends and an outer surface 44 that defines part of an exterior 46 of the hood 34. The hood interior 42 extends between a first hood opening 48 at a first end 50 of the hood 34 and a second hood opening 52 at a second end 54 of the hood 34. The second hood opening 52 is adjacent to and aligned with the gland passage 36 and the second end 54 of the hood 34 is adjacent to and may be in contact with the gland 32 in the assembled state of the cable assembly 10. The first end 50 of the hood 34 is open, may define the first hood opening 48, and is received adjacent to and may partially axially overlap the connector 14. The sidewall 38 may be circumferentially continuous and may provide a barrier surrounding the end of the cable 12 adjacent to the connector 14. The first and second hood openings 48, 52 may be sized to permit the connector 14 to pass through the hood 34, such that the hood 34 can be installed onto the cable 12 with the connector 14 already attached to the cable 12. In at least some implementations, suitable seals to prevent contaminants from entering the hood interior 42 may be provided between the hood 34 and the gland 32 and/or the hood 34 and cable 12, as desired. As used herein, terms like axial or axially, radial or radially and circumferential or circumferentially relate to the central axis 20 of the cable 12.

With the hood 34 designed to permit installation onto the cable 12 with the connector 14 already attached to the cable 12, the hood interior 42 and the hood openings 48, 52 are larger than and shaped to permit the cable 12 to pass therethrough. To more securely arrange the cable 12 relative to the hood 34, the cable assembly 10 includes an adapter 56. The adapter 56 is secured to the cable 12 and is received within the hood interior 42. To receive the cable 12, the adapter 56 includes a first adapter opening 58 at a first end 60 of the adapter 56 and a second adapter opening 62 at a second end 64 of the adapter 56 and an internal cavity 66 that is communicated with the adapter openings 58, 62. An exterior of the adapter 56 may be sized and shaped for close receipt within the hood interior 42, if desired, to limit relative movement or play between them. Further, a connector, such as a threaded fastener 68 as shown in FIGS. 2 and 3, may be installed through an opening in the hood 34 sidewall 38 and engaging the adapter 56 or within an aligned opening of the adapter 56, to connect the adapter 56 to the hood 34 and inhibit or prevent relative movement between them. In FIG. 3, the threaded fastener 68 is shown without the hood 34 for illustrative purposes only.

To permit the adapter 56 to be fitted onto the cable 12 with the connector 14 already attached to the cable 12, the adapter 56 includes a first part 70 and a second part 72 that is movable relative and releasably connectable to the first part 70. The adapter 56 is elongated and has the shape of a rectangular cube, and the cable 12 extends along a longitudinal central axis 12 of the adapter 56 between the first and second parts 70, 72. Both the first part 70 and the second part 72 define at least a portion of the adapter openings 58, 62 and the adapter cavity 66. When the adapter 56 is in a first opened position, the first part 70 and the second part 72 are arranged to permit the cable 12 and/or part of the connector 14 to be received within the openings 58, 62 and the adapter cavity 66.

When the adapter 56 is in a second closed position, the cable 12 is secured within the adapter cavity 66, at least one of the openings 58, 62 may be smaller than the connector 14 such that the connector cannot be moved with respect to the opening. In the second position, the first part 70 and second part 72 may be coupled together, as shown in FIG. 3, by a connector or engaged connection features 74 of the parts 70, 72, if desired. One or both adapter parts 70, 72 may be movable relative to the other part to define the first and second positions of the adapter 56, which may be constructed in different ways.

The adapter 56 can be made of a plastic material. More preferably, the adapter 56 is made of a material with increased flexibility, such as an elastomeric material (e.g., silicone, rubber). The channel passing through the opening 62 can be sized to form a friction fit with the outer sheath 22 of the cable 12, thereby providing additional strain relief.

In the implementation shown in FIGS. 2 and 3, the adapter 56 is a clamshell type structure with the first part 70 and the second part 72 connected together by a hinge 76 (FIG. 3) that extends along a side of the adapter 56, for example as shown extending in a longitudinal direction at an elongated side between the first and second ends 60, 64 of the adapter 56 and parallel to or generally parallel to (i.e. within ten degrees of parallel) the cable axis 20. In this example, the first part 70 and the second part 72 both extend to the first and second ends 60, 64 of the adapter 56 and are separable along a plane that extends parallel to and through the hinge 76, and the parts 70, 72 include oppositely facing interior surfaces 78, 80 (FIG. 2) that define the internal cavity 66. The interior surfaces 78, 80 are farther apart in the first position than in the second position.

The hinge 76 may be a separate component from either or both of the adapter parts 70, 72, or it may be a so-called “living hinge 76” defined by a thin section of material that defines the adapter parts 70, 72, which may be formed from the same piece of material in a unitary structure (i.e., the hinge 76 is integrally formed with a perimeter edge of the adapter parts 70, 72). So arranged, the adapter parts 70, 72 may be pivoted or hingedly moved relative to each other to the first position in which the cable 12 can be inserted into the adapter cavity 66 and then to the second position in which the cable 12 is locked to the adapter 56 whereby removal of the cable 12 from the adapter 56 is inhibited or prevented.

The first and second parts 70, 72 of the adapter 56 may include connection features 74 by which the parts are releasably coupled together, such as by a snap-fit or other arrangement. In the example of FIG. 3, the first part 70 includes a barb 82 that is releasably received in a window 84 of a flange 86 of the second part 72 when the adapter 56 is in the second position. The flange 86 is sufficiently flexible to move outward to slide over the barb 84 until the barb 82 is aligned with the window 84, at which point the flange 86 is spring biased back inward so that the barb 82 enters the window 84 to releasably lock the barb 82 to the flange 86. The flange 86 and barb 82 may be located on a side of the adapter 56 opposite to the hinge 76, or elsewhere, as desired. The flange 86 may snap over the barb 82 when the adapter 56 is moved to the second position, at which the flange 86 is releasably locked with the barb 82 and thereby the adapter 56 is locked to the cable 12, and the flange 86 may be flexed outward to clear the barb 82 to move the adapter 56 from the first position to or toward the second position. The adapter 56 can be removed from the cable 12 by pulling the flange 86 outward until it clears the barb 82, and then separating the first and second parts 70, 72. Of course, other connection features and arrangements may be used, as desired.

In the example shown, the adapter 56 has a length between the ends 60, 64 such that the adapter 56 engages a stop surface 88 (FIG. 2) in the hood interior 42 and overlaps part of the connector 14, while leaving the connector contacts 28 accessible from an outside of the hood 34 and so that the connector 14 is accessible for coupling with a mating connector. So arranged, the hood 34 may be axially trapped between the adapter 56 and the gland 32, and the hood 34 may, as noted above, be connected to the adapter 56 such as by a fastener 68.

To form the cable assembly 10, the gland 32 is slid over the connector 14 and on the cable 12 and then the second end 54 of the hood 34 is slid over the connector 14 until the connector 14 is exposed from the first distal end 50 of the hood 34 sufficiently to permit the adapter 56 to be installed on the cable 12. For example, the cable 12 can be extended until the connector 14 extends a distance from the end of the first distal end 50 of the hood 34 that is greater than the length of the adapter 56, so that the adapter 56 can be fully positioned between the first distal end 50 and the connector 14. The adapter 56 is opened or moved to the first position and the cable 12 is inserted into the adapter cavity 66 with the connector 14 exposed from the first adapter opening 58 and the cable 12 extending out of the second adapter opening 62. The adapter 56 is then closed or moved to the second position so that part of the cable 12 is trapped within the adapter 56.

Next, the hood 34 can be slid back toward the connector 14 until the adapter 56 is received within the hood interior 42 and abuts the stop surface 88 within the hood 34. If provided, the fastener 68 can be installed to couple the hood 34 to the adapter 56 and limit or prevent relative movement between them. Finally, the gland 32 can be slid toward and into contact with the second end 54 of the hood 34, and then secured to the cable 12. The gland 32 can be threadably coupled with the hood 34 and screwed into the hood 34 to provide a watertight connection. The gland 32 can be secured to the cable 12 by a fastener.

The cable assembly 10 provides strain relief to the cable 12 and the connector 14. The gland 32 is coupled to the second proximal end 54 of the hood 34, for example the gland 32 can be threadably coupled to the hood 34, or coupled by a fastener or the like. That prevents the cable 12 from sliding longitudinally forward and rearward with respect to the adapter 56 and the hood 34. The force of any rearward pulling on the cable 12 would be on the gland 32, and not on the connector 14. In addition, the hood 34 is fixedly coupled to the adapter 56 by the fastener 68, which further provides strain relief to the connector 14. The adapter proximal end 64 engages the stop surface 88 of the hood 34 to prevent the cable 12 from sliding rearward out of the adapter 56 and the hood 34. And, the adapter 56 can prevent the cable 12 from rotating (clockwise and counterclockwise) with respect to the adapter 56. Thus, the connector 14 remains at a fixed position with respect to the adapter 56 and the hood 34.

The cable 12 end is now provided with a robust hood 34 and gland 32 arrangement, and this was accomplished with the connector 14 attached to the cable 12 and without having to cut off the connector 14 or later attach the connector 14 to the cable 12 after installation of the gland 32 and hood 34 on the cable 12. The hood 34 may be grasped by a person when plugging the connector 14 into and removing the connector 14/cable assembly 10 from a mating connector. The hood 34 and gland 32 may inhibit contaminants from fouling the connector 14 and cable 12, and the hood 34 may be connected to a structure to maintain the cable assembly 10 coupled to the structure, such as, but not limited to, a bulkhead, cabinet or the like.

The hood 34 is made of a rigid material such as a metal or rigid plastic. The adapter 56 can be rigid or somewhat flexible, and can be plastic or alternatively a metal. The first end is shown to have an outer flange that can be utilized to connect to a corresponding bulkhead connector, though other shapes and connection interfaces can be provided.

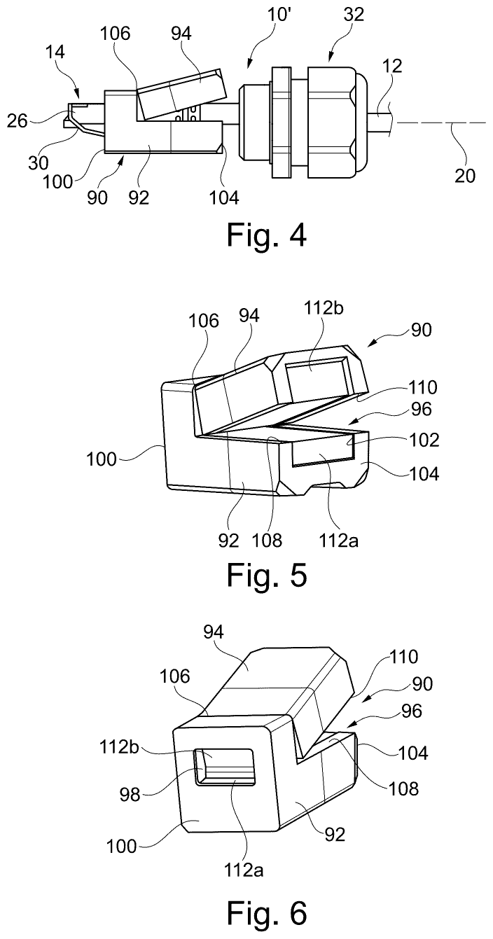

Another adapter 90 for a cable assembly 10′ is shown in FIGS. 4-6 with the hood 34 removed/not shown for purposes of illustrating the adapter 90. This adapter 90 can be used with the same cable 12, connector 14, hood 34 and gland 32, and for ease of description, the same reference numerals will be used as those used with regard to the embodiment shown in FIGS. 1-3. As noted above with regard to adapter 56, adapter 90 can be used with other types of cables 12 and connectors 14, as desired.

The adapter 90 includes a first part 92 and a second part 94 that define an interior cavity 96, and a first opening 98 (FIG. 6) at a first end 100 of the adapter 90 and a second opening 102 (FIG. 5) at a second end 104 of the adapter 90. In this example, the first part 92 is coupled to the second part 94 at a hinge 106 for hinged or pivoted movement about a line or axis that is perpendicular to the axis 20 of the cable 12 and the hinge 106 overlies the cable 12 (whereas in FIGS. 1-3, the hinge 76 of adapter 56 was parallel to and offset from the side of the cable 12). In the example shown, the first part 92 is coupled to the second part 94 between the first and second ends 100, 104 of the adapter 90, and the second part 94 does not extend to or define part of one end of the adapter 90, shown as the first end 100 in this example. As shown, the hinge 106 is positioned between the first distal end 100 and the second proximal end 104 of the adapter 90, and in some embodiments the hinge 106 is substantially closer to the first end 100 (approximately one-third the length of the adapter 90) to guide the connector 14 into and through the first rear opening 98.

The second part 94 extends to the second end 104 of the adapter 90, and so the second opening 102 is defined by both the first part 92 and second part 94, but the first opening 98 is defined only within the first part 92 (and is bounded on all sides by material of the first part 92). The cavity 96 is defined between and by oppositely facing interior surfaces 108, 110 of the first part 92 and the second part 94, and these interior surfaces 108, 110 (which together define the interior cavity 96) are farther apart in the first open position than in the second closed position. Of course, the second part 94 could be coextensive with the first part 92 such that the second part 94 also defines part of the first opening 98, if desired, or the second part 94 could define part of the first opening 98 but not the second opening 102.

In at least some implementations, the adapter 90 includes at least one flexible or compliant body 112 that defines at least part of the adapter cavity 96 at the first part 92 and/or the second part 94, and which may be carried by or connected to one or both of the adapter parts 92, 94. The compliant body 112 is arranged to engage one or both of the connector 14 and the cable 12, and to deform against and around the connector 14 or cable 12 when the adapter 90 is closed or moved to the second position. The compliant body 112 may damp vibrations, provide insulation and/or provide a seal or structure that inhibits contaminants from entering the adapter cavity 96. In the example shown, a first compliant body 112a is carried by the first part 92, a second compliant body 112b is carried by the second part 94. The compliant bodies 112 may extend along any length of the adapter 90 between the ends of the adapter 90 and they may have any desired thickness and width. In at least some implementations, the compliant bodies 112 engage each other on opposite sides of the cable 12 when the cable 12 is received in the adapter 90 and the adapter 90 is in the second position, to provide a peripherally (e.g. circumferentially) continuous seal around the cable 12, and/or the connector 14.

In the embodiment shown, the first part 92 is elongated and forms a base having a first distal end portion, a second proximal end portion, and an intermediate portion therebetween, which together form a general L-shape. The first distal end portion of the first part 92 has a rectangular or square cross-section, and the window 98 is formed in the first distal end portion. The intermediate portion and second proximal end portion have a general U-shape cross-section with a bottom and side walls. The bottom and side walls define a first channel which receives the rectangular or square first compliant body 112b. A rearward mating ledge is formed between the intermediate portion and the first distal end portion. The hinge 106 is formed at the top edge of the ledge, between the intermediate portion and the first distal end portion.

The second part 94 is elongated and forms a cover with a top and side walls that forms a similar U-shape cross section that is aligned with and inverted with respect to the base. The top and side walls form a second channel that is aligned with the first channel, and the second channel receives the rectangular or square second compliant body 112a. The first and second parts 92, 94 form a rigid protective outer housing.

To form the cable assembly 10′, the gland 32 is slid over the connector 14 and on the cable 12 and then the second end 54 of the hood 34 is slid over the connector 14 until the connector 14 is exposed from the hood 34 sufficiently (as with the embodiment of FIGS. 1-3) to permit the adapter 90 to be installed on the cable 12. The adapter 90 is opened or moved to the first position in which, at the second end 104 of the adapter 90, the second part 94 is spaced from the first part 92. The connector 14 is inserted into the adapter cavity 96 from the second end 104 of the adapter 90, and is passed through the first opening 98 of the adapter 90 until some or all of the connector 14 is out of or exposed from the first opening 98 and with the cable 12 extending out of the second opening 102 or second end 104 of the adapter 90. The second part 94 is only shown partially open in FIGS. 4-6, and can be opened wider, such as up to about 90 degrees with respect to the first part 92. The adapter 90 is then closed or moved to the second position so that part of the cable 12 is trapped within the adapter 90, between the first part 92 and the second part 94. Next, the hood 34 can be slid back toward the connector 14 until the adapter 90 is received within the hood interior 42 and abuts the stop surface 88 within the hood 34. If provided, a fastener 68 can be installed to couple the hood 34 to the adapter 90 and limit or prevent relative movement between them. Finally, the gland 32 can be slid toward and into contact with the second end 54 of the hood 34, and then secured to the cable 12.

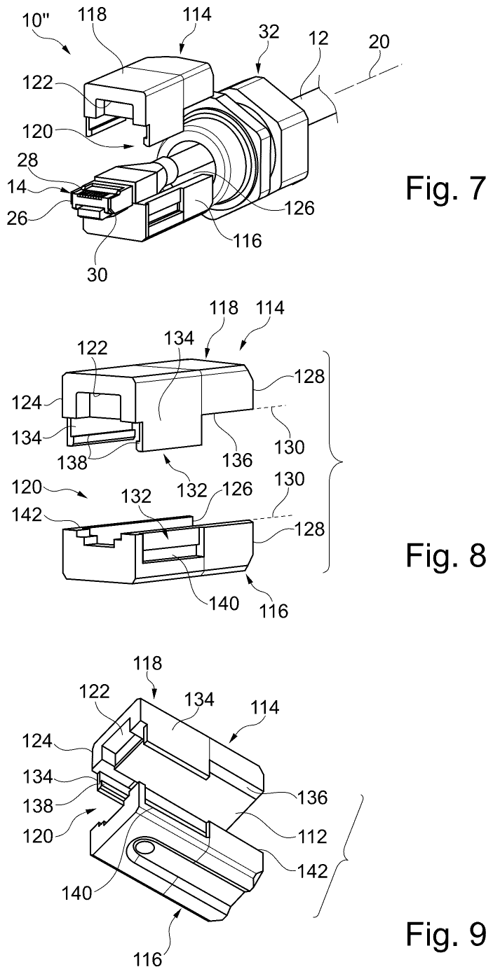

Another adapter 114 for a cable assembly 10″ is shown in FIGS. 7-9, with the hood removed 34 from the assembly shown in FIG. 7, to better illustrate the adapter 114. This adapter 114 can be used with the same cable 12, connector 14, hood 34 and gland 32, and for ease of description, the same reference numerals will be used as those used with regard to the embodiment shown in FIGS. 1-3. As noted above with regard to adapter 56, adapter 114 can be used with other types of cables 12 and connectors 14, as desired.

The adapter 114 includes a discrete first part 116 and a discrete second part 118 that is separate from the first part 116, and together define an interior cavity 120 between them. A first opening 122 is provided at a first end 124 of the adapter 114 and a second opening 126 is provided at a second end 128 of the adapter 114. In this example, the first part 116 and second part 118 are separable along a parting line 130 or plane that is parallel to the cable axis 20 to permit the adapter 114 to be opened (e.g. moved to the first position) for receipt of the cable 12 and/or part of the connector 14 therein. In the example shown, both parts 116, 118 extend to the first and second ends 124, 128 of the adapter 114 and both parts define portions of both openings 122, 126 in the adapter 114, but other arrangements can be utilized (e.g. where one opening is formed by only one of the parts). One or both of the adapter parts 116, 118 may include a compliant body 112 at the first part 116 and/or the second part 118 that defines part of the adapter cavity 120.

The first and second adapter parts 116, 118 may include one or more cooperating connection features 132 that releasably or yieldably couple the parts together, such as by a press-fit, interference fit, snap-fit or the like. The parts 116, 118 could also be connected by a separate fastener or retainer, like a clip or screw or clamp, or by an adhesive or weld, as desired. As shown in FIGS. 8 and 9, the second part 118 includes flanges 134 that extend from opposite sides of the second part 118 and beyond an interior surface 136 of the second part 118 and which include inwardly extending tabs 138. The first part 116 includes corresponding slots or cavities 140 extending into opposite sides of the first part 116 below an interior surface 142 thereof, and arranged to receive the tabs 138 when the second part 118 is received on the first part 116 and the adapter 114 is in the second position. Multiple connection features 132 could be provided to enable multiple positions of the second part 118 relative to the first part 116, with sliding relative motion (movement parallel to the parting line 130 or plane parallel to a cable axis) between the parts. For this purpose, the length of the slots or cavities 140 can be greater than the width of the flanges 134 in order to enable displacement.

This can facilitate insertion of the cable 12 and connector 14 into the adapter 114 in one position in which the interior surfaces 136, 142 of the first and second parts 116, 118 are farther apart than in a second position, without requiring complete separation of the first and second parts 116, 118.

To form the cable assembly 10″, the gland 32 is slid over the connector 14 and on the cable 12 and then the second end 54 of the hood 34 is slid over the connector 14 until the connector 14 is exposed from the hood 34 sufficiently (as with the embodiment of FIGS. 1-3) to permit the adapter 114 to be installed on the cable 12. The adapter 114 is opened or moved to the first position by pulling the flange 134 outward to remove the inward tabs 138 from the slot 140 and then pulling the first and second parts 116, 118 apart to separate the first and second parts 116, 118, and the cable 12 is inserted into the adapter cavity 120 with the connector 14 exposed from the first opening 122 and the cable 12 extending out of the second opening 126. The adapter 114 is then closed or moved to the second position so that the inward tabs 138 enter the slot 140 and so that part of the cable 12 is trapped within the adapter 114. Next, the hood 34 can be slid back toward the connector 14 until the adapter 114 is received within the hood interior 42 and abuts the stop surface within the hood 34. If provided, the fastener can be installed to couple the hood 34 to the adapter 114 and limit or prevent relative movement between them. Finally, the gland 32 can be slid toward and into contact with the second end 54 of the hood 34, and then secured to the cable 12.

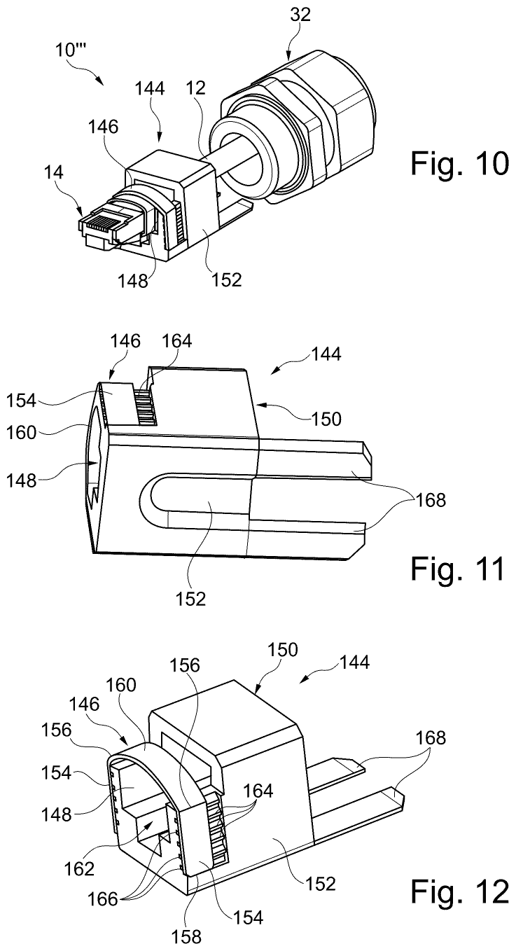

Another adapter 144 for a cable assembly 10′″ is shown in FIGS. 10-12, with the hood 34 removed from the assembly shown in FIG. 10, to best illustrate the adapter 144. This adapter 144 can be used with the same cable 12, connector 14, hood 34 and gland 32, and for ease of description, the same reference numerals will be used as those used with regard to the embodiment shown in FIGS. 1-3. As noted above with regard to adapter 56, adapter 144 can be used with other types of cables and connectors, as desired.

The adapter 144 is similar to the adapter 114 of FIGS. 7-9 and has a first part 152 and a second part 146. The second part 146 defines part of only opening (shown as the first opening 148) and not also the second opening 150 which is defined entirely by the first part 152, in this example. In the example shown, the first part 152 is a base that has a distal end portion, an intermediate portion and a proximal end portion. The distal end portion has a general U-shape cross section with a bottom and side walls extending upward from the bottom to define an adapter cavity 162 therebetween. The distal end portion forms a cable mating section that includes one or more slots or recesses 164 that extend longitudinally along the outer surface of the side walls at least partly along the distal end portion. The intermediate portion has a general square or rectangular cross-section and further defines the adapter cavity 162. The proximal end portion includes one or more elongated flat flanges 168 that extend from the proximal end of the intermediate portion to the proximal end of the adapter 144.

The second part 146 is a U-shaped body having two spaced apart flanges or legs 154 that each have a first end 156 and a second end 158 opposite to the first end 156, and a curved central portion 160 connected to the first end 156 of each leg 154. The second part 146 can be thin to form a clip that extends about and releasably engages the outer sides of the distal portion of the first part 152. In this example, an inner surface of the central portion 160 of the U-shaped body defines an interior surface of the second part 146 that defines part of the adapter cavity 162, and the central portion 160 is arranged to overlie part of the connector 14 and/or the cable 12, to secure the cable 12 relative to the adapter 56. As shown, the adapter cavity 162 can have the general shape of the connector 14, with a bottom channel that receives the retaining feature of the connector 14.

Each leg 154 of the second part 146 includes one or more connection features that cooperate with mating or cooperating connection features on the first part 152 to releasably couple the parts together, and/or to permit slidable movement of the parts to separate or move closer together the interior surfaces of the parts. In the implementation shown, the connection features of the adapter parts 152, 146 are defined by the multiple slots or recesses 164 in opposite outer side surfaces of the first part 152, and by one or more tabs 166 extending inward from the inner surfaces of the legs 154 and arranged for receipt in a slot or recess 164 of the first part 152 when the legs 154 are arranged outboard of the side surfaces of the first part 152, as shown in FIGS. 10 and 11. So arranged, the second part 146 can be moved (upward/downward or inward/outward) relative to the first part 152 to enlarge or reduce the size of the first opening 148 to facilitate insertion of the connector 14 through the first opening 148 and then securing the connector 14/cable 12 in the adapter 56. The second part 146 can be removed by flexing the legs 154 outward and moving the second part 146 away from the first part 152. Or, by sliding the second part off of the first part 152. Further, a stop tab can be placed at the distalmost end of the slots 164 to prevent the second part 146 from sliding off the distal end 156 of the first part 152.

In the implementation shown, the first part 152 further includes rearwardly extending flanges 168 adapted to engage a stop surface 88 in the hood 34 to locate the adapter 144 relative to the hood 34. The cable assembly 10′″ can be formed in the same manner described above, with reference to adapter 114, for example.

While specifically shown and described in a couple of the embodiments (e.g., FIGS. 4-6, 7-9) of the adapters (e.g., adapters 10′, 10″), one or more compliant or flexible bodies 112 or seals or insulators, etc., may be used in all forms of adapters, as desired (e.g., including any of the adapters 10, 10″ of FIGS. 1-3, 10-12). Further, in assembly, the retaining tabs or other retaining feature of a connector 14 can be received outside the adapter 56 or they can be actuated (e.g. depressed/flexed as shown in FIG. 2) by the adapter 56 to prevent operation of the retaining tab 30 to prevent their interference from connection and disconnection of the connector 14 with a mating connector. This can be useful, for example, when the hood 34 is coupled to a structure like a bulkhead or cabinet (e.g. by a coupler or fastener) such that other retainers avoid unintended decoupling of the mated connectors and the retaining tab 30 is not needed to maintain a connection.

Thus, the hood protects against water, dust and dirt and provides strain relief. The hood and adapter also cooperate to center the cable 12 and connector 14 when mating.

It is noted that in the embodiments shown and described, the adapter can be removably attached to the hood and/or to the cable. In other implementations, the adapter need not be removable, but can be fixed to the hood and/or to the cable.

It is further noted that the drawings may illustrate and the description and claims may use several geometric or relational terms and directional or positioning terms, such as rectangular cube, between, planar, elongated, curved, surrounds, perpendicular, flat, top, bottom, side, distal, and proximal. Those terms are merely for convenience to facilitate the description based on the embodiments shown in the figures, and are not intended to limit the disclosure. Thus, it should be recognized that the disclosure can be described in other ways without those geometric, relational, directional or positioning terms. In addition, the geometric or relational terms may not be exact. For instance, walls or surfaces may not be exactly flat, perpendicular or parallel to one another but still be considered to be substantially perpendicular or parallel because of, for example, roughness of surfaces, tolerances allowed in manufacturing, etc. And, other suitable geometries and relationships can be provided without departing from the spirit and scope of the disclosure.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A cable assembly, comprising:
a cable including an outer sheath and at least one conductor within the sheath;
a connector coupled to an end of the cable, the connector having at least one contact that is coupled to the at least one conductor;
an adapter having a first part and a second part that define an adapter cavity, a first adapter opening at a first end of the adapter and a second adapter opening at a second end of the adapter, and the first part and the second part being movable relative to each other; and
a hood having a sidewall that defines a hood interior and includes a first hood opening at a first end of the hood and a second hood opening at a second end of the hood, wherein the adapter has a first position in which part of the cable may be inserted into the adapter cavity, and the adapter has a second position in which the part of the cable is trapped within the adapter, in the second position the cable extends out of the second adapter opening and the connector extends out of the first adapter opening, and wherein the adapter is received within the hood interior so that the connector extends at least partly out of the first opening and the cable extends through the second opening.

2. The cable assembly of claim 1 wherein the sidewall of the hood is circumferentially continuous along at least part of a length of the hood between the first end and the second end.

3. The cable assembly of claim 2 which includes a retainer that couples together the hood and the adapter to retain a position of the adapter in the hood interior.

4. The cable assembly of claim 1 wherein the adapter includes a seal that engages and surrounds a periphery of part of the connector to provide a seal between the adapter and the connector.

5. The cable assembly of claim 1 wherein the adapter includes a hinge between the first part and the second part that permits hinged relative movement between the first part and the second part.

6. The cable assembly of claim 5 wherein the hinge extends in a direction parallel to a central axis of the cable.

7. The cable assembly of claim 6 wherein the adapter is a clamshell body.

8. The cable assembly of claim 5 wherein the hinge extends in a direction perpendicular to a central axis of the cable.

9. The cable assembly of claim 1 wherein the first part is separate from the second part in the first position of the adapter and the first part is releasably coupled to the second part in the second position of the adapter.

10. The cable assembly of claim 9 wherein the first part and the second part have complementary connection features that are releasably connected in the second position of the adapter.

11. The cable assembly of claim 9 wherein the first part is a U-shaped body having two spaced apart legs each having a first end and a second end opposite to the first end, and the U-shaped body has a central portion connected to the first end of each leg, and wherein the U-shaped body is connected to the second part of the adapter by connection features on the legs and so that the central portion overlies part of the connector.

12. The cable assembly of claim 1 wherein the adapter includes a compliant body that defines at least part of the adapter cavity, and which is compressed against one or both of the connector and the cable in the second position of the adapter.

13. The cable assembly of claim 1 wherein the connector includes a retainer tab arranged to releasably retain the connector in a socket of a mating connector, and wherein the retainer tab is located outside of the adapter.

14. The cable assembly of claim 13 wherein the adapter when in the second position moves the retainer tab to a position permitting removal of the connector from said mating connector.
